(19) United States
(12) Patent Application Publication
(10) Pub. No.: US 2006/0283334 A1
(43) Pub. Date: Dec. 21, 2006

(54) Multipurpose waffle iron set

(76) Inventor: Wei-Teh Ho, Taipei (TW)

Correspondence Address: WEI-TEH HO, P O BOX 24-108, TAIPEI, TW

(21) Appl. No.: 11/155,866

(22) Filed: Jun. 20, 2005

(51) Int. Cl. A47J 37/06

(52) U.S. Cl. 99/372

(57) ABSTRACT

A multipurpose waffle iron set is disclosed to include a waffle iron formed of two symmetrical iron plates for making waffles, and a griddle for placing on one iron plate of the waffle iron for cooking foods, which griddle having a center area thereof curved upwards and perforated, an oil groove around the border, and a drip hole for guiding oil out of the oil groove to the inside of one iron plate of the waffle iron.

### BACKGROUND OF THE INVENTION

1. Field of the Invention

The invention relates to a cooking utensil and more particularly, to a multipurpose waffle iron set, which comprises a waffle iron for making waffles or the like, and a griddle for use with one iron plate of the waffle iron for cooking meat, hotdog, etc.

2. Description of the Related Art

Western-style food has been popularly invited in recent years. Western-style cookies, cakes, foods, food materials can easily be purchased from nearby shops, distribution centers, department stores, etc. Further, a housekeeper may use a flat pan or oven to cook different foods. However, these devices are not designed for cooking all different foods, and some foods may be partially burned when cooked. Therefore, different cooking devices such as waffle iron, hotdog machine, gas barbecue grill, etc. are developed for different cooking purposes. However, it is not economic to prepare many different cooking devices that may be not frequently used. Further, these cooking devices require a big storage space when not in use.

### SUMMARY OF THE INVENTION

The present invention has been accomplished under the circumstances in view. It is therefore the main object of the present invention to provide a multipurpose waffle set, which can be used to make waffles or the like as well as to cook meat, hotdog and other dry foods. It is another object of the present invention to provide a multipurpose waffle set, which has a simple structure and low manufacturing cost. To achieve these and other objects of the present invention, the multipurpose waffle iron set comprises a waffle iron and a griddle. The waffle iron comprises two iron plates hinged together with a hinge, each iron plate having a plurality of recessed portions for making waffles, two handles respectively affixed to the iron plates remote from the hinge, a retaining ring pivoted to one handle and adapted to secure the two handles together, and a drip bowl affixed to the periphery of one iron plate. The griddle for can be placed on one iron plate of the waffle iron for cooking meat, hotdog, and any of a variety of other dry foods, having a center area thereof curved upwards and perforated. Further, the griddle has an oil groove extending around the border for collecting oil dripped from the cooking food, and a drip hole for guiding oil out of the oil groove to the drip bowl at the waffle iron.

### BRIEF DESCRIPTION OF THE DRAWING

FIG. 1 is an exploded view of a multipurpose waffle iron set according to the present invention.

FIG. 2 is an elevational open view of the waffle iron of the multipurpose waffle iron set according to the present invention.

FIG. 3 is a cutaway view of a part of the multipurpose waffle iron set, showing the griddle used with one iron plate of the waffle iron.

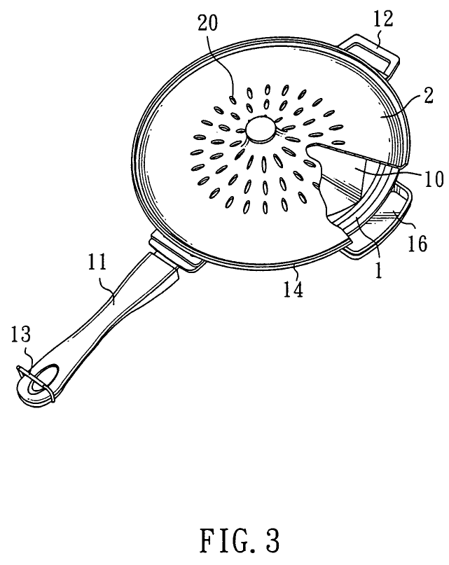

### DETAILED DESCRIPTION OF THE PREFERRED EMBODIMENT

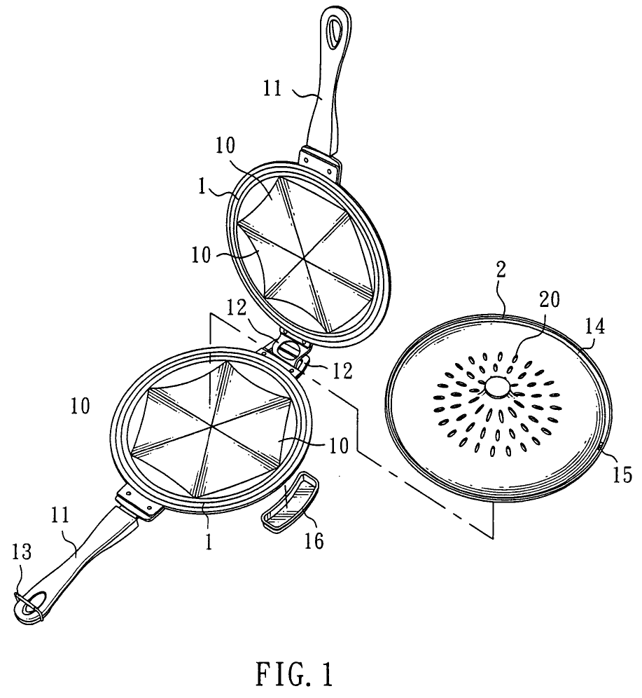

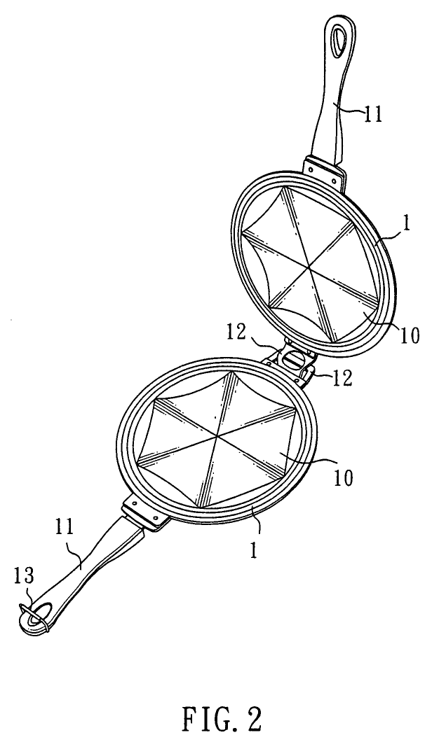

Referring to FIGS. 1 and 2, a multipurpose waffle iron set in accordance with the present invention is shown comprising a waffle iron, and a griddle 2. The waffle iron comprises two iron plates 1 hinged together with a hinge 12, each iron plate 1 having a plurality of recessed portions 10 for making waffles, two handles 11 respectively affixed to the iron plates 1 remote from the hinge 12, a retaining ring 13 pivoted to the free end of one of the handles 11 and adapted to secure the two handles 11 together when the two iron plates 1 are closed, and a drip bowl 16 affixed to the periphery of one of the iron plates 1. The griddle 2 is a circular plate member having the center area thereof curved upwards. The griddle 2 further has a plurality of through holes 20 over the upwardly curved center area, an oil groove 14 extending along the border, and a drip hole 15 cut through the top and bottom walls in the oil groove 14.

The waffle iron can be used independently without the griddle 2 for making waffles, quesadillas, or the like. When making waffles, quesadillas, or the like, the waffle iron is kept open on the gas burner or heat source, and then the prepared food material is poured into the recessed portions 10 of one iron plate 1 at the gas burner or heat source, and then the two iron plates 1 are closed and the handles 11 are secured together by the retaining ring 13.

When wishing to cook meat, hotdog, etc., the griddle 2 is placed on one iron plate 1 of the waffle iron at the gas burner or heat source after removal of the other iron plate 1 from the waffle iron, and then meat, hotdog, etc., is placed on the griddle 2 for cooking. Because meat, hotdog, etc. is placed on the griddle 2 above the iron plate 1 at the gas burner or heat source and because the griddle 2 has through holes 20 over the center area, meat, hotdog, etc. will not be singed. Further, oil produced from food during cooking will be collected by the oil groove 14 and guided to the recessed portions 10 of one iron plate 1 or the drip bowl 16 through the drip hole 15.

A prototype of multipurpose waffle iron has been constructed with the features of FIGS. 1˜3. The multipurpose waffle iron functions smoothly to provide all of the features discussed earlier.

Although a particular embodiment of the present invention has been described in detail for purposes of illustration, various modifications and enhancements may be made without departing from the spirit and scope of the invention. Accordingly, the invention is not to be limited except as by the appended claims.

1-4. (canceled)

5. A multipurpose waffle iron set comprising:
a) a first iron plate having:
I) a first hinge portion;
ii) a first handle; and
iii) a plurality of first recessed portions, each of the plurality of first recessed portions radiating outwardly from a center of thereof;
b) a second iron plate having:
I) a second hinge portion pivotally connected to the first hinge portion, the first hinge portion and the second hinge portion are selectively connected and separated;
ii) a second handle; and
iii) a plurality of second recessed portions, each of the plurality of second recessed portions radiating outwardly from a center of thereof; and
c) a griddle selectively located on one iron plate selected from a group consisting of the first iron plate and the second iron plate and having a circular center plate member protruding upwardly from a center thereof.

6. The multipurpose waffle iron set according to claim 5, wherein the griddle has an oil groove located on a outer periphery thereof.

7. The multipurpose waffle iron set according to claim 6, wherein the griddle has a drip hole located in the oil groove, the oil groove communicating with a top of the one iron plate through the drip hole.

8. The multipurpose waffle iron set according to claim 5, wherein the griddle has a plurality of through holes located around the circular center plate member.

9. The multipurpose waffle iron set according to claim 5, further comprising a retaining ring pivotally connected to the first handle and selectively locking the second handle in a predetermined position relative to the first handle.

10. The multipurpose waffle iron set according to claim 5, further comprising a drip bowl connected to the one iron plate.
